(19) United States
(12) Patent Application Publication
(10) Pub. No.: US 2026/0350725 A1
(43) Pub. Date: Nov. 5, 2026

(54) System and Method for Generation and Analysis of Synthetic Jury Deliberations and Decisions

(71) Applicant: James Worthington, New York, NY (US)

(72) Inventor: James Worthington, New York, NY (US)

(21) Appl. No.: 19/738,128

(22) Filed: Jul. 10, 2026

Related U.S. Application Data
(63) Continuation of application No. 18/936,954, filed on Nov. 4, 2024, now abandoned.
(60) Provisional application No. 63/596,261, filed on Nov. 4, 2023.

(51) Int. Cl. G06Q 50/18

(52) U.S. Cl. CPC G06Q 50/18

(57) ABSTRACT

A system for generating and analyzing synthetic jury deliberations, in which the jury's constituent synthetic members are generated with a large language model or other method of artificial intelligence and have evaluative and deliberative characteristics that correspond to specified profiles, and the factual record, presented questions, deliberative procedures, and rules of decision can be specified, varied, and analyzed. The system may be used to generate and analyze synthetic jury deliberations and decisions in both legal and non-legal contexts, to analyze the relative significance of various input specifications defining the synthetic jury deliberations, and may be used to generate both individual synthetic jury deliberations and large volumes of iteratively varied deliberations and decisions for analysis.

### CROSS REFERENCE TO RELATED APPLICATION

This application is a continuation of U.S. patent application Ser. No. 18/936,954, filed on Nov. 4, 2024, which claims the benefit of U.S. Provisional Patent Application No. 63/596,261, filed on Nov. 4, 2023, each of which is incorporated by reference in its entirety.

### BACKGROUND

The present invention is directed to a system and method for synthetically generating and analyzing deliberative processes using simulated juror-agents, generated by large language models or comparable artificial intelligence methods, applying specified rules of deliberation and decision to specified factual records.

With the recent rapid growth and utilization of large language models (LLMs), there has been increasing interest in their application across various sectors, including political, economic, and legal domains. Several recent academic studies have explored the capabilities of LLMs to simulate political partisanship, economic behaviors, and lobbying roles, and the use of LLMs as a tool of population-scale and large-group study is an emerging focus in the field of computational social science.

However, the state of the art has yet to address modeling of small group deliberative processes, such as those engaged in by a jury, legislative committee, or legislature, which involve complex analysis, group and individual interactions, and iterative decision-making based upon presented factual records and governed by individual juror characteristics, interpersonal interactions, internal deliberations, and decision-making rules. Nor does the current state of the art permit analysis of synthetic deliberative processes in which key inputs (participant characteristics, rules of decision or deliberation, factual records, etc) can be systematically controlled and varied across repeated iterations of synthetic deliberations in order to assess their relative significance and to model the features influencing a deliberative jury's decision making processes and outcomes.

### SUMMARY

Juries are frequently tasked with making high-stakes decisions applying specified legal (or other) deliberation and decision-making procedures on the basis of a factual record. The present invention provides a means by which a synthetic jury process can be generated in which the jury's component members have evaluative and deliberative characteristics that correspond to specified profiles, and the factual record and rules of deliberation and decision can be modified and analyzed.

The legal system is a particularly high-profile environment in which a jury is frequently granted significant, and in many cases decisive, decision-making authority through the jury's assessment of a factual record under specified legal rules of deliberation and decision. In one embodiment of the present invention, the system is deployed to iteratively generate synthetic mock trial results, in order to test the potential effect of calculated variations of juror characteristics, evidentiary presentations, and/or rules of deliberation or decision. In other embodiments, the system is deployed using statistical techniques such as monte carlo modeling to generate and analyze samples of output deliberative processes and decision outcomes based upon variations of juror characteristics, factual records, and/or rules of deliberation or decision.

Deliberative juries are also employed in numerous other situations of decision-making in the context of specified factual prompts, such as legislative bodies, awards of grants or prizes or assessments, product development, or evaluation of political advertising or political candidates or strategies. In other embodiments of the invention, the system is deployed to synthetically represent deliberative jury decision-making processes in these and other non-legal contexts, allowing analysis of the deliberative processes and conclusions that result from submission to a jury of specified factual prompts under specified rules of deliberation and decision.

In the present application, the term “jury” refers to any deliberative collective decision-making body. In some embodiments, a “jury” may be tasked with evaluating facts under conditions designed to be analogous to those defining a legal proceeding, but in other embodiments, a “jury” may be designed to be analogous to a legislative body, for example.

### BRIEF DESCRIPTION OF THE DRAWINGS

FIG. 1 shows a flowchart presenting an exemplary method for generating a synthetic jury deliberative process for analysis.

FIG. 2 shows a flowchart presenting an exemplary method for generating a sample of multiple synthetic jury deliberative processes for statistical modeling and analysis.

FIG. 3 shows an example of an operating environment in which one or more embodiments of the specification may be implemented.

### DETAILED DESCRIPTION

The present application discloses systems and methods for synthetically generating deliberative processes using juror-agent identities, generated by large language models or comparable artificial intelligence methods, applying specified rules of deliberation and decision to specified factual records. The drawings in the present application and this detailed description are directed to exemplary implementations, but the present disclosure may also be implemented differently from the specific implementations discussed herein.

### Individual Deliberative Process Simulation

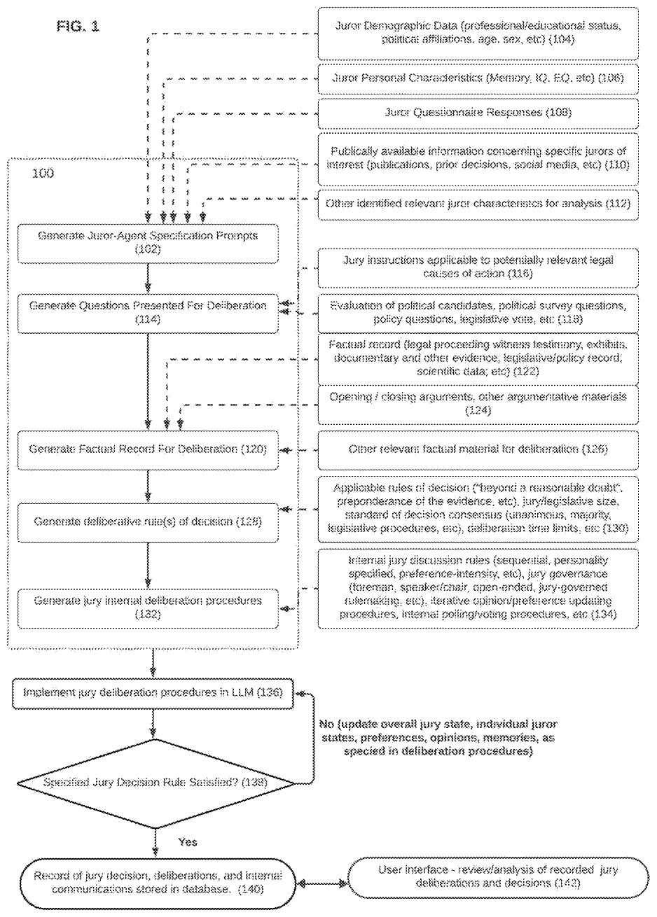

FIG. 1 illustrates a flowchart of an example method for generating synthetic deliberative processes and decisions. In other embodiments, the depicted process steps may be executed in different orders or with different input information, depending upon available data and/or analytic objectives. The present invention may be implemented on any appropriate hardware or computing platform allowing access to large language models or comparable artificial intelligence capabilities, including but not limited to computing hardware allowing local implementation of such methods or remote implementation through network or internet access to appropriate large language model or comparable artificial intelligence capabilities.

The synthetic jury procedures in the embodiment depicted in FIG. 1 are specified in aggregate through the large language model prompts and procedures identified within the dashed lines labeled 100.

In this embodiment, the synthetic jury is comprised of a plurality of juror-agents, each of which is defined through specifications generated at step 102 through prompting of a large language model (“LLM”) or similar artificial intelligence means with a prompt or prompts specifying relevant juror characteristics. Such characteristics can be based upon any characteristics or information determined to be relevant, including but not limited to past juror data from one or more relevant jurisdictions, juror questionnaire responses (106), demographic data (104), social science survey data (104), social characteristics such as introversion or extroversion (106), personal characteristics such as memory (106), IQ (106), EQ (106), professional background (104), political preferences (104), conversational behavioral preferences (106), publicly available personal information (such as social media data) to the extent lawful and permissible (110), or any other data determined to be relevant in light of the anticipated jurisdiction, factual record, questions for decision and/or applicable rules of decision (112). In other embodiments, the synthetic jury is comprised of a single juror-agent. In other embodiments, a synthetic jury may be employed to model potential deliberations and decisions of a legislative body, in which case there may be significant publicly available information available to specify the synthetic juror characteristics. In other embodiments, for example where a synthetic jury will be employed to model potential deliberations and decisions of specific known decision-makers, such as the members or a judicial or arbitration panel, the juror-agents may be prompted with past decisions of such decisions-makers and relevant context (110), in addition to or in lieu of the information described above.

At step 114, the questions to be deliberated by the synthetic jury are generated. In one embodiment, wherein a pending or anticipated legal dispute will be submitted to a synthetic jury, generation of questions may be performed through identification of causes of action and of the corresponding claim elements and jury instructions applicable in the relevant actual or anticipated jurisdiction or jurisdictions (116). The juror-agents are then provided with large language model prompts presenting the generated questions. In other embodiments, the questions presented can encompass any questions, including non-legal questions such as evaluation of political candidates, potential political policies, proposed legislation (118) or assessment of the effectiveness of commercial advertising, to be presented to the synthetic jury for deliberation.

At step 120, the factual record to be presented to the synthetic jury is generated. In one embodiment, wherein a pending or anticipated legal proceeding will be submitted to a synthetic jury, the factual record is generated based upon actual or anticipated witness testimony, exhibits, documents, and/or other evidence (122). It is important to note that the factual record generated in such an embodiment may include material that would not be classified as factual material in an actual legal proceeding, including, for example, synthetic opening and/or closing statements or other arguments (124). In some instances, for example in simulation of a legislative body through a synthetic jury, the factual record may take the form of scientific evidence, policy analyses, and journalistic/opinion commentary relevant to the deliberations of the modeled legislative body. In some embodiments, a prompt presenting the undivided factual record in its entirety is presented to the synthetic jury. In other embodiments, the factual record may be divided into sub-sections, including but not limited to sub-sections each corresponding to the factual record generated in a single day of a court-room proceeding, or a single session of public discussion and debate, which may then be presented sequentially to the synthetic jury. In such embodiments, the juror-agent characteristics may include specifications defining the juror-agent capacities to identify and later recall significant evidence from any specific sub-division of factual record (106). In other embodiments, the factual record presented consists of facts generated in other, non-legal, contexts, such as policy records or public statements of one or more politicians, an advertising campaign, or characteristics of a commercial product (126).

At step 128, the rules of decision to be applied by the synthetic jury in its deliberations are generated and submitted through a large language model prompt or prompts to the synthetic juror-agents. In one embodiment, wherein a pending or anticipated legal dispute will be submitted to a synthetic jury, such rules of decision may be generated based upon applicable legal or other (such as legislative) rules of decision (130), such as the standard of proof that will govern decision-making (“beyond a reasonable doubt”, “preponderance of the evidence”, etc), the number of juror-agents who will participate in deliberations, and the standard of consensus that will apply (unanimity, majority vote, etc). In other embodiments, the rules of decision are tailored as necessary to the questions to be presented to the jury, including rules of decision that may not require any decision to be reached at all, for example rules that may require a specified amount of group deliberation but do not require any particular degree of consensus before a jury decision is concluded.

At step 132, rules governing the internal deliberative procedures of the synthetic jury are generated and submitted through a large language model prompt or prompts to the synthetic juror-agents (134). In one embodiment, such deliberations may take the form of a single vote, without further interaction among the juror-agents. In other embodiments, such deliberations may take the form of iterative interaction and communication among the juror-agents in a synthetic deliberative discussion environment permitting iterative interaction among the LLM juror-agents. In such embodiments, the rules of deliberation may include specification of rules governing deliberative interactions (such as sequential interactions, preference-intensity governed interactions, interactions governed by juror-agent personality specifications, etc), time limits governing the communications among the juror-agents, rules governing the permissibility of private vs public communications among the juror-agents, election of a synthetic “jury foreman”, or rules by which the juror-agents may be authorized to define the rules of deliberation that will then govern their subsequent deliberations. Rules of deliberation also include rules governing the procedures for iterative updating of juror opinions in response to jury deliberations, rules governing formation of juror memories of current and past opinions, other juror-agent memory updating, recall of deliberations, and/or iterative jury re-polling procedures, for example.

At step 136, the prompts, rules of decision, and deliberative procedures identified in aggregate in section 100 are applied to implement a synthetic deliberative environment through a large language model until the decision rule(s) specified at step 128 is satisfied. This can result in either a single instance of jury deliberation and decision, or repeated iterative updating (step 138) of the synthetic jury model state and individual juror-agent states until the specified decision rule(s) is satisfied.

The resulting record of the synthetic jury deliberations and decision or decisions, documenting both the final jury decision and the iterative record of internal jury deliberation and internal jury discussion are recorded in a database (step 140). This database is made available to the user through an interface allowing review and analysis of the recorded deliberations and decisions (at step 142). By way of illustration only, such analysis could include assessment of (i) juror profiles and characteristics having the greatest/least impact upon the synthetic jury's internal deliberative processes, (ii) factual record material (evidence) having the greatest/least impact upon the synthetic jury's internal deliberative processes, (iii) the synthetic jury's application of specified rules of decision and the impact of variations to these rules of decision, and other issues of interest to assessment of a jury's deliberative process and decision.

### Statistical Analysis of Multiple Deliberative Process Simulations

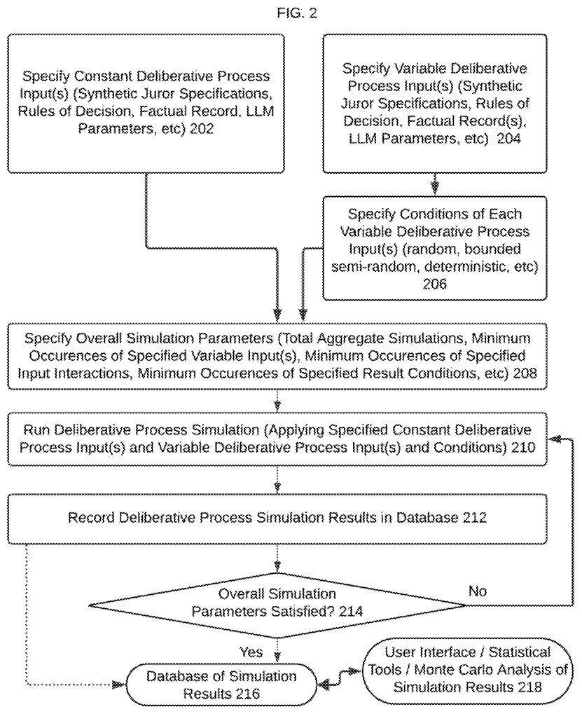

In some embodiments, the invention includes generation of multiple iterative synthetic jury deliberations, including iterations involving variations to none, some or all of the deliberative process features specifying juror-agent characteristics and/or the submitted factual record, rules of decision, or rules of deliberation, among other relevant modes of variation. FIG. 2 illustrates a flowchart, reflecting an embodiment in which certain parameters specifying deliberative process inputs may be held constant (each, a constant deliberative process input (202)), and certain parameters specifying deliberative process inputs may be varied (each, a variable deliberative process input (204)) each according to specified parameters defining its terms of variation (206), such as random, semi-random bounded within specified range(s) of variation, deterministic, or other specified terms.

For example, in one embodiment, at step 204, a variable deliberative process input may consist of a range of characteristics of synthetic jurors defined such that the statistical characteristics of a large sample of such synthetic jurors is calculated to align with the known characteristics (such as demographics, political preferences, educational and economic characteristics, etc) of a relevant jurisdiction or potential population of jurors. Conversely, such characteristics may instead be held constant in order to focus analysis on other factors and variables, and thus specified as a constant deliberative process input (202).

In another embodiment, at step 204, a variable deliberative process input may consist of different potential rules of decision (such as a range of different formulations of jury instructions defining legal causes of action to be presented to a jury in a legal proceeding) for testing. Conversely, such rules of decision may instead be held constant in order to focus analysis on other factors and variables, and thus specified as a constant deliberative process input (202).

In another embodiment, at step 204, a variable deliberative process input may consist of a range of possible factual records, each including or excluding different factual materials being evaluated for inclusion or exclusion in a possible legal proceeding. Conversely, a factual record may instead be held constant in order to focus analysis on other factors and variables, and thus specified as a constant deliberative process input (202).

In another embodiment, at step 204, a variable deliberative process inputs may consist of varying specifications of large language model parameters, including but not limited to model “temperature” (output variability). Conversely, such large language model parameters may instead be held constant in order to focus analysis on other factors and variables, and thus specified as a constant deliberative process input (202).

In other embodiments, at steps 204 and 206 combinations of different such possible deliberative process inputs may be specified in a variety of permutations, in order to allow, for example, for analysis of the relative significance of and potential interactions between various potential variable deliberative process inputs.

Overall simulation parameters are also specified (208), specifying conditions governing the generation of a set of synthetic jury deliberations for analysis. In some embodiments, such conditions may include specification of the total number of deliberation simulations, a minimum number of occurrences of one or more specified variable deliberative process inputs, a minimum number of occurrences of specified deliberative process results (for example, and without limitation, simulations of the jury process in a possible legal proceeding might be specified to be repeated until one thousand simulated verdicts for the plaintiff have been generated for subsequent analysis and study), a minimum number of occurrences of specified combinations of constant and variable deliberative process inputs, etc. One skilled in the art will recognize that numerous specifications of overall simulation parameters are possible under this disclosure, each tailored to address questions of potential interest to a practitioner analyzing the potential actions of a jury under varied conditions and input specifications.

Multiple iterative synthetic jury deliberations are then generated (210), applying the specified deliberative process inputs (constant (202) and variable (204 and 206)) iteratively in a synthetic deliberative environment. Documentation of both the resulting generated deliberative process and the deliberative process concluding results are recorded (212) in a database (216) as they are generated.

Throughout the process of running multiple iterative deliberative process simulations, the results of each such deliberative process are available for review and ongoing statistical analysis through a user interface (218) providing tools for such review of individual deliberative process results and statistical analysis of the aggregate database of deliberative process simulations. Upon satisfaction of the specified simulation parameters (208), the simulations are completed (214). Upon or prior to such completion, the database of deliberative process simulations may be subjected to statistical analysis, including the application of monte carlo tools analyzing the distribution(s) of simulation results under the specified variation(s) of input conditions and interactions and the relative significance of various constant and varied deliberative process inputs.

In some embodiments, the variations generated through the depicted process are generated deterministically. In other embodiments, the variations are generated randomly, semi-randomly within specified boundaries, or through other means calculated to identify relevant variables affecting the resulting deliberative processes and decisions. Through iterative revision to the criteria producing variations to juror-agent characteristics and/or the submitted factual record, rules of decision, or rules of deliberation, by way of example and not limitation, the significance and/or relevance of such variable deliberative process inputs may be isolated and analyzed. For example, some embodiments are designed to isolate critical juror characteristics while holding other factors constant (or within limited bounds of variation). Other embodiments are designed to isolate and test the effect of variations to the questions presented, factual record, or rules of deliberation or decision, for example and without limitation, while holding the jury characteristics constant (or within limited bounds of variation).

### System Implementation

The system disclosed in this specification is implemented through computer hardware and program components. The referenced computer hardware consists of one or more computers configured to perform the specified operations and actions through installed software, firmware, hardware, or a combination of them that in operation cause the system to perform the disclosed operations or actions. This configuration to perform particular operations and actions occurs through the installation of programs with instructions that, when executed by data processing apparatus, cause the apparatus to perform the specified operations or actions.

The term “data processing apparatus” encompasses all kinds of apparatus, devices, and machines, tangible and/or virtual, for processing data, including by way of example a programmable processor, a computer, multiple processors or computers, or any execution environment for computer programs. Embodiments of this specification can be implemented in digital electronic circuitry, in tangibly-embodied computer software or firmware, in computer hardware, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them.

A computer program or computer programs embodying the disclosed specification can be written in any form of programming language and can be deployed in any form. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations.

In this specification, the terms “large language model” or “LLM” are used broadly to refer to artificial intelligence foundation models capable of being directed through training (generally on massive language datasets) and prompting to generate responsive text consistent with specified conditions and queries. For example, a large language model (currently exemplified by such commercial available LLMs as GPT-4 or Claude 3) once prompted with specified demographic characteristics will generally (typically subject to specifiable bounds of variation) provide responses to queries in a range consistent with the range of responses that might be provided by human respondents sharing such characteristics.

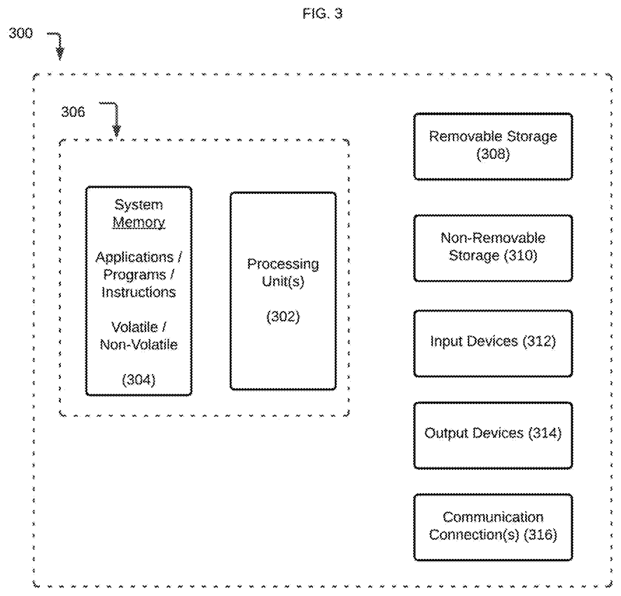

FIG. 3 illustrates a suitable operating environment for the specification. In its most basic configuration, a suitable operating environment (300) typically includes at least one processing unit 302 and memory 304. Depending on the exact configuration and type of computing device(s), memory 304 (storing instructions to perform the processes disclosed herein) may be volatile (such as RAM), non-volatile (such as ROM, flash memory, etc.), or some combination of the two. This most basic configuration is illustrated in FIG. 3 by dashed line 306. Further, environment 300 may also include storage devices (removable, 308, and/or non-removable, 310) including, but not limited to, magnetic or optical disks, tape, or other media. Similarly, environment 300 may also have input device(s) 312 such as keyboard, mouse, hand-controls, HMD, pen, voice input, etc. and/or output device(s) 314 such as a display, speakers, printer, etc. Also included in the environment may be one or more communication connections, 316, such as LAN, WAN, Bluetooth, point to point, etc.

The operating environment (300) typically includes at least some form of computer readable media. Computer readable media can be any available media that can be accessed by processing unit 302 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

The operating environment 300 may consist of one or more computers operating in a networked environment using logical connections to one or more remote computers. The remote computer may be a personal computer, a server, a router, a network PC, a peer device or other common network node, and typically includes many or all of the elements described above as well as others not so mentioned. If the relevant large language model(s) to be utilized in an embodiment must be accessed remotely, then such networking connections are necessary, but the present invention also encompassed embodiments in which the relevant large language model(s) are implemented locally on a processing unit.

The embodiments described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices may be employed to perform the functionality disclosed herein without departing from the scope of the disclosure.

While this specification contains many specific implementation details, these should not be construed as limitations on the scope of the invention or on the scope of what may be claimed, but rather as descriptions of features that may be specific to particular embodiments of the specification. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are shown in the drawings and recited in the claims in a particular order, this should not be understood as requiring that such operations be performed in the particular order shown or in sequential order, or that all illustrated operations be performed, to achieve desirable results. Although particular embodiments of the subject matter have been described, other embodiments are within the scope of the specified claims. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

A person of ordinary skill in the art would recognize that changes can be made to the details of the embodiments described herein without exceeding the scope of the disclosed invention. Embodiments of the invention may include some, none or all of the features described herein as applying to any particular embodiments. The patentable scope of the disclosed invention is defined in the claims, and may include other embodiments that occur to one skilled in the art.

1. A computer-implemented method comprising:
iteratively generating, using one or more artificial intelligence models, a plurality of synthetic jury deliberations from a set of deliberative process inputs, wherein a first subset of the deliberative process inputs is held constant and a second subset is varied across the plurality of synthetic jury deliberations according to one or more variation conditions, the generating continuing until one or more specified aggregate simulation parameters are satisfied;
storing, for each synthetic jury deliberation, a record of the deliberation and a resulting decision; and
providing, via an output device, a user interface enabling statistical analysis of the resulting decisions as a function of variation in the second subset.

2. The method of claim 1, wherein the deliberative process inputs comprise:
defined juror characteristics of a plurality of synthetic jurors prompted using the one or more artificial intelligence models;
a record presented to the synthetic jurors; one or more questions; one or more rules of decision; and
one or more rules of deliberative procedure applied until the rules of decision are satisfied.

3. The method of claim 1, wherein the one or more artificial intelligence models comprise a large language model.

4. The method of claim 1, wherein the second subset comprises an output-variability parameter of the one or more artificial intelligence models.

5. The method of claim 1, wherein the one or more aggregate simulation parameters comprise a minimum number of occurrences of a specified deliberation result condition.

6. The method of claim 2, wherein the defined juror characteristics of at least one synthetic juror are derived from demographic characteristics of an actual or anticipated jury pool of a specified jurisdiction.

7. The method of claim 2, wherein the defined juror characteristics of at least one synthetic juror are derived from past decisions of an identifiable member of a judicial panel, an arbitration panel, or a legislative body.

8. The method of claim 2, wherein the record is divided into subsections presented sequentially, and the defined juror characteristics specify each synthetic juror's capacity to retain in memory one or more of the subsections.

9. The method of claim 1, wherein the user interface enables monte carlo analysis of the stored records and determination of the relative significance of the second subset with respect to the resulting decisions.

10. The method of claim 1, wherein the deliberative process inputs are derived from a pending or anticipated legal proceeding.

11. The method of claim 1, wherein the deliberative process inputs are derived from a political, legislative, commercial, advertising, or other non-litigation context.

12. A computer-implemented method for simulating a plurality of synthetic deliberative jury processes, wherein the synthetic jury, deliberations, and decisions are simulated through a large language model, the method comprising:
for each of the plurality of synthetic deliberative jury processes, implementing a synthetic deliberative environment in which a plurality of individual synthetic jurors, each prompted with defined juror characteristics, iteratively apply specified deliberative procedures to a presented record and presented questions until specified rules of decision are satisfied, each synthetic deliberative jury process being defined by a set of features comprising (i) the defined juror characteristics, (ii) the record, (iii) the questions, (iv) the rules of decision, and (v) the deliberative procedures;
designating a first subset of the features as constant across the plurality of synthetic deliberative jury processes, and a second subset of the features as varied across the plurality of synthetic deliberative jury processes according to one or more specified variation conditions;
generating the plurality of synthetic deliberative jury processes until one or more specified aggregate simulation parameters are satisfied, the one or more aggregate simulation parameters comprising at least one of: a target total number of processes;
a minimum number of occurrences of a specified value of a varied feature; a minimum number of occurrences of a specified interaction between two or more varied features; or a minimum number of occurrences of a specified deliberation result condition;
storing, for each synthetic deliberative jury process, a record of the deliberations and a resulting decision; and
providing, via an output device, a user interface enabling statistical analysis of the resulting decisions as a function of variation in the second subset of the features.

13. The method of claim 12, wherein a varied feature comprises an output-variability parameter of the large language model.

14. The method of claim 12, wherein the one or more aggregate simulation parameters comprise a minimum number of occurrences of a specified deliberation result condition.

15. The method of claim 12, wherein the defined juror characteristics of at least one synthetic juror are derived from demographic characteristics of an actual or anticipated jury pool of a specified jurisdiction.

16. The method of claim 12, wherein the defined juror characteristics of at least one synthetic juror are derived from past decisions of an identifiable member of a judicial panel, an arbitration panel, or a legislative body.

17. The method of claim 12, wherein the user interface enables monte carlo analysis of the stored records and determination of the relative significance of the second subset of the features with respect to the resulting decisions.

18. A system comprising:
one or more processing units; and
one or more computer-readable storage media storing instructions that, when executed by the one or more processing units, cause the system to:
iteratively generate, using one or more artificial intelligence models, a plurality of synthetic jury deliberations from a set of deliberative process inputs, wherein a first subset of the deliberative process inputs is held constant and a second subset is varied across the plurality of synthetic jury deliberations according to one or more variation conditions, until one or more specified aggregate simulation parameters are satisfied;
store, for each synthetic jury deliberation, a record of the deliberation and a resulting decision; and
present, via an output device, a user interface enabling statistical analysis of the resulting decisions as a function of variation in the second subset.

19. The system of claim 18, wherein the one or more aggregate simulation parameters comprise a minimum number of occurrences of a specified deliberation result condition.

20. The system of claim 18, wherein the user interface enables monte carlo analysis of the stored records and determination of the relative significance of the second subset of the features with respect to the resulting decisions.
